(19) United States
(12) Patent Application Publication
(10) Pub. No.: US 2005/0259668 A1
(43) Pub. Date: Nov. 24, 2005

(54) Method of providing broadband services in client dense environments

(76) Inventor: Kwang N. Kim, Vienna, VA (US)

Correspondence Address: Alfred F. Hoyte, Esq., Suite 700, 733 15th Street, N.W., Washington, DC, 20005, US

(21) Appl. No.: 10/851,892

(22) Filed: May 24, 2004

(51) Int. Cl. H04L 12/66

(52) U.S. Cl. 370/401

(57) ABSTRACT

A method and apparatus for implementing wireless internet connections for a plurality of portable computing devices located within a given area or hotspot. The invention employs a combination of wired and wireless links to manage propagation effects of the transmitted signal and to reduce interference with signals transmitted in adjacent spaces. In accordance with one aspect of the invention, the existing wiring infrastructure at the hotspot, which may be coaxial cable for CATV, is used as the wired segment. A broadband signal, containing internet data obtained from a central computer, is transmitted from a plurality of access points. The signals transmitted from the access points are injected onto the existing wiring, with the broadband signal isolated from the data or power signals carried by the wiring infrastructure. At the outlet ends of the coaxial cable, the broadband signals are separated from the existing data or power signals and coupled to high efficiency antennas which radiate a signal throughout the corresponding living or activity space. In the case of a hotel room, for example, the signal is broadcast for reception anywhere within the hotel room. In accordance with one aspect of the method of the invention, the broadband signals are broadcast from the various access points using several carrier frequencies or channels, and distribution of the channels is arranged to avoid adjacent room same channel interference.

### BACKGROUND OF THE INVENTION

1. Field of the Invention

The present invention relates to internet technology. More particularly, the invention is directed to a method and apparatus for facilitating wireless bi-directional communication between a central computer and a plurality of relatively closely spaced personal computers located within a single venue.

2. Description of the Prior Art

Internet use has been on the increase ever since the early 1990s, with many new products and services being offered to facilitate all types of personal and commercial endeavors. As a result, laptop computers, PDAs, and other portable computing devices have been promoted and refined in recent years to allow for wireless internet access at virtually any place the portable device can be taken.

One way of facilitating communication with the internet using a portable computing device involves the use of a wireless LAN technology known as “Wi-Fi”, which is short for “wireless fidelity”. This technology facilitates internet access for a plurality of computing devices located at a designated venue, which is known as a “hotspot”, such as an airport or hotel.

With the introduction of Wi-Fi technology and hotspots in public areas, the demand for accessing high speed data, also known as broadband, by the general population has increased significantly in the last few years, with projections indicating that in the next few years there will be tens of thousands of these hotspots. One of the primary reasons for the increase is the ease with which internet users can obtain high speed internet access. The most popular hotspots are cafés, bookstores, hotels, restaurants, airports, conference centers, and marinas where people can access the internet easily via their Wi-Fi enabled laptops or PDAs. Typically, these hotspots are connected to the internet as a backhaul connection via T1/E1, cable modems, wireless, or DSL. Typical backhaul connection speed is less than 1.5 Mbps.

Wi-Fi equipment is based on the IEEE 802.11 standard, it is sometimes referred to as wireless Ethernet to emphasize the linkage with the traditional wired Ethernet 802.3. In other words, Wi-Fi equipment is designed and certified to work with wired Ethernet products. There are currently several 802.11/b/a/g standard products available. The most popular 802.11b product is based on the 2.4 GHz ISM band and operates at a data rate of up to 11 Mbps, which is more than 9 times faster than the typical backhaul connection speed. Recently certified products based on IEEE 802.11g standard, are also based on 2.4 GHz ISM band and operate at data rates of up to 54 Mbps.

A typical hotspot based on current Wi-Fi products has the following characteristics:

1. Typical data speed of the backhaul connection is 1.5 Mbps or less.

2. Maximum data speed of Wi-Fi products is 54 Mbps with an effective range of about 150 feet in open space.

3. Multiple access point devices are needed to cover client-dense venues such as hotels and apartments. Poor placement of the access points, limited transmitted power, poor channel planning, and coverage problems that are unique to the building structure are the main reasons for the high cost of deploying the Wi-Fi solution in highly dense environments.

Because of limited backhaul connection speed, e-mail, web surfing, and accessing corporate networks via VPN are the most popular applications that are used in hotspots. Data speed of 300 Kbps is sufficient to run these applications. However, running multimedia applications such as video on demand, distance learning, training, and stream video advertisements requires much higher bandwidth at the hotspots. To solve this problem, each hotspot requires a local cache gateway that interfaces with a backhaul connection as well as wireless access points. Essentially, the local cache gateway stores the information such as advertisements, training materials, or movies, downloaded in non real time from the central server and then plays back the information in real time when client devices request the information. This implementation is relatively straightforward for a hotspot location where only one access point is required. However, when several access points are required, the aforementioned problems relating to transmission of the broadband signal arise. Accordingly, it would be desirable to provide an efficient and cost effective way of providing wireless broadband internet connection for a plurality of portable computing devices located within a predetermined venue, especially when that venue covers a large area and is partitioned into separate rooms or living spaces.

### SUMMARY OF THE INVENTION

Briefly, the invention comprises a method and apparatus for implementing wireless internet connections for a plurality of portable computing devices located within a given large area venue. The invention employs a combination of wired and wireless links to manage propagation effects of the transmitted signal and to reduce interference with signals transmitted in adjacent spaces within the venue. In accordance with one aspect of the invention, the existing wiring infrastructure at the venue, which may be coaxial cable for CATV or satellite TV, is used as the wired segment. A broadband signal, containing internet data obtained from a central computer at a relatively low data rate, is transmitted from a local cache gateway to a plurality of access points at a relatively high data rate. The signals transmitted from the access points are injected onto the existing wiring also at a relatively high data rate, with means provided to isolate the broadband data signal from the data or power signals carried by the wiring infrastructure. At the outlet ends of the coaxial cable, the broadband signals are separated from the existing data or power signals and coupled to high efficiency antennas which radiate a signal throughout the corresponding living or activity space. In the case of a hotel room, for example, the signal from the high efficiency antenna is broadcast for reception anywhere within the hotel room. In accordance with another aspect of the method of the invention, the broadband signals are broadcast from the various access points using several carrier frequencies or channels, and distribution of the channels is arranged to avoid adjacent room same channel interference. In accordance with another aspect of the invention, the broadband signal may be any broadband signal such as a cell phone signal.

Accordingly, it is a principal object of the invention to provide a network architecture for the distribution of a wireless broadband internet signal throughout a given venue at a high data rate.

It is a major object of this invention to provide a network architecture for the bi-directional communication of digital data between a local cache gateway and a plurality of client devices within a given area at a relatively high data rate, while said local cache gateway bi-directionally communicates digital data with a central computer at a relatively low data rate.

It is another object of the invention to provide a network architecture for the distribution of a wireless broadband internet signal throughout a given area having both wired and wireless segments.

It is another object of the invention to provide a network architecture for the distribution of any wireless broadband signal throughout a given area having both wired and wireless segments.

It is another object of the invention to provide a method for distributing a broadband signal throughout a partitioned building using the existing wiring infrastructure.

It is another object of the invention to provide a method for delivering multimedia content in real time throughout a local area network having at least one wireless segment.

Finally, it is a general goal of the invention to provide improved elements and arrangements thereof in an apparatus fully effective in accomplishing its intended purposes.

These and other objects of the present invention will become readily apparent upon further review of the following specification and drawings.

The present invention meets or exceeds all the above objects and goals. Upon further study of the specification and appended claims, further objects and advantages of this invention will become apparent to those skilled in the art.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 shows an overview of the system of the invention.

FIG. 2 shows a block diagram of the hybrid network of the invention.

FIG. 3 shows a block diagram of a wall unit used with the hybrid network of the invention.

FIG. 4 shows an actual layout implementation of a diplexer and splitter network.

FIG. 5 shows a circuit layout of a wall unit diplexer.

FIG. 6 illustrates channel distribution within a structure having a wiring infrastructure adapted for use with the hybrid network of the present invention.

### DETAILED DESCRIPTION OF THE PREFERRED EMBODIMENTS

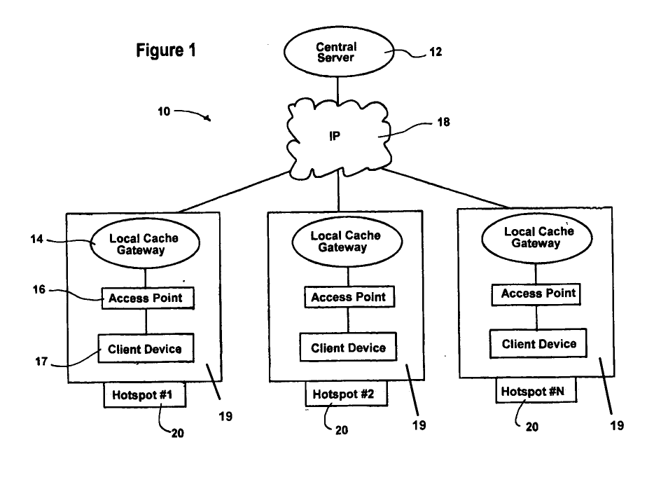

Referring now to FIG. 1, an overview of the system 10 of the present invention is shown. It can be seen that the system comprises four main elements; the central server 12, the local cache gateways 14, the access points 16, and the computing devices or client devices 17 which allow the individual users or clients to communicate with the central server 12 and access the internet 18. The central server 12 communicates to a plurality of local cache gateways 14, which may be located in geographically disparate locations, via the internet 18. Each venue or hotspot 20 has at least one local cache gateway 14, one or more access points 16, and one or more client devices 17.

The central server 12 performs the usual functions of network resource management and ensures a uniform connection experience for users operating client devices 17 connected to the various gateways 14. The local cache gateways 14 and access points 16 are managed and monitored by the central server 12. Authentication, authorization, and accounting functions are all handled by the central server 12. In one aspect of the invention, the central server 12 distributes commercial software products or any content to the various local cache gateways 14. The software products or other content may then be downloaded from the gateways 14 via the various access points, obviating the need for individual client devices 17 to directly access the internet 18, as is the case with all WLAN arrangements. Storing the software or content at the gateway 14 streamlines the software purchasing process greatly, and the cost to the consumers as well as the download times are correspondingly reduced. As an additional benefit, security is greatly enhanced, as the authorizing and accounting functions are handled between the gateway 14 and the central server 12, allowing for much more sophisticated firewall and security protocols than a client device connected directly to, e.g. a phone line. Also, as the gateway 14 can store large amounts of data from the central computer 12 for later broadcast to client devices at high speed in real time, the apparent download speed to the user of the client device 17 is greatly enhanced.

In order to provide uniform internet access for all client devices 17 on a wireless LAN (WLAN), and to allow for real time access to multimedia content for all client devices 17 at the hotspot, a local cache gateway 14 is required. It should be noted here that the WLAN 19 of the present invention is defined by the network extending from the local cache gateway 14 to the various client devices 17 or end terminals as will be explained in more detail later. The local cache gateway 14 may be a server such as a Dell® Power Edge 4600 server, and is connected to the central computer 12 via a relatively slow backhaul link which may be, for example, the existing telephone lines etc., the backhaul link being understood to encompass that portion of the physical infrastructure of the internet 18 between the local cache gateway 14 and the central computer 12. Typically a local cache gateway 14 has two logical interfaces, one to the backhaul internet connection allowing for connection to the internet 18 for two-way communication between the central server 12 and the gateway 14, the second interface allowing for two way communication between the gateway 14 and the access points 16. Each hotspot 20 has at least one gateway 14 which has stored therein, in addition to the operating system software and data transfer protocols, multimedia and application software. Each gateway 14 distributes, in response to client device 17 requests, multimedia and applications software such as music, movies, mpeg video images, training materials, proprietary software products, all in real time if necessary. It can be appreciated that client devices 17 would not be able to access certain multimedia applications in real time by directly accessing the internet 18 due to bandwidth constraints. To that end the gateway 14 preferably has a very large memory capacity, on the order of 20 to 1000 gigabytes. This large memory capacity, combined with the high bandwidth capability of the gateway 14 and the WLAN 19 of the present invention allows for each hotspot 20 to be a retail point of sale for various multimedia and software products, with the capability to transmit these products, which are stored at the gateway 14 to several client devices 17 in a client dense environment at a relatively high data rate. A key aspect of the invention is that the communication of data along the WLAN 19 is at a much higher speed or rate than the speed at which the gateway 14 communicates with the central computer 12.

As has been previously mentioned, each gateway 14 is capable of transmitting data at very high speeds, up to 9 times the speed available with the typical backhaul connection, between the gateway 14, the internet 18, and the central server 12. The Wi-Fi equipment utilized to transfer data along the WLAN 19 is based on the IEEE 802.11 standard, sometimes referred to as the wireless internet. A standard 802.11b product is based on the 2.4 GHz ISM band, operating at a data rate of up to 11 Mbps, with recently certified products based on the 802.11g standard capable of operating at data rates of up to 54 Mbps. Thus, a hybrid WLAN with a locally high bandwidth can be facilitated using 802.11 products, with the local cache gateway 14 allowing for video games, etc. to be downloaded to the client devices 17 at a relatively high speed in a manner transparent to the user.

In addition to controlling the high speed transmission of data between the gateway 14 and the client devices 17, the gateway 14 can monitor and control all of the access points 16 on the WLAN 19, with access point 16 activity transmitted to the central server 12. The gateway 14 also controls the bandwidth and maintains the integrity of data transfer along the WLAN 19.

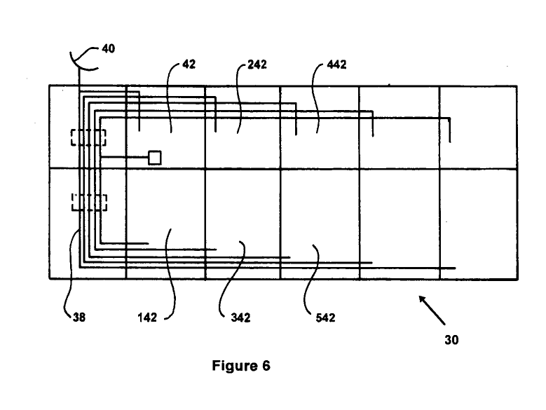

Distribution of high speed data within the infrastructure of the hotspot 20 is accomplished in part by using the existing wiring at the hotspot 20. The hotspot 20 may be a single structure 30 (FIG. 6), several adjoining structures 30, or other predetermined area hardwired for the distribution of cable television signals, electrical power, telephones signals, etc., such as a marina or train station, the system of the present invention only requires that the wiring be physically continuous throughout the various structures 30 or area to facilitate distribution by a single gateway 14. If there are several structures 30 not electrically connected by a single wiring network, additional gateways 14 may be required.

The existing wiring at the hotspot 20 may be either CAT 3 twisted pair wiring, CAT 5 twisted pair wiring, AC power line, or TV coaxial cabling. Most hotels and apartments already have coaxial line and CAT 3 wiring infrastructure for video (TV) and voice (telephone) applications, and of course all buildings have AC wiring.

Several technologies are readily available for delivery of broadband service to each room 42 or common area of venues 20 such as hotels, apartments, or office buildings. For wireless technologies, many products are available based on standard IEEE 802.11/a/b/g. This technology offers flexibility in the placement of client devices 17 and minimizes the need to modify the existing wiring within the structure 30. As previously mentioned, 802.11b products are designed to transmit data at a maximum data rate of 11 Mbps, with an effective range of about 150 feet in open space. However, in practice, a lower data rate is expected, and the effective range is dependent on the obstructions placed between the access point 16 and receiver, i.e., laptop or other client device. For 802.11g products, a maximum data rate of 54 Mbps is supported, which is significantly faster than the backhaul internet 18 connection between the central computer 12 and the gateway 14 which may be limited to only 600 or 700 kbps or less. The radio spectrum for these products operates in the unlicensed bands around 2.4 GHz and 5.8 GHz, and consequently, the link is limited by constraints on power spectral density and by propagation effects to about 90 feet per access point 16 and it requires large outlays in network hardware to cover client-dense environments. In particular, there are serious multi-path, fading, and mutual interference effects that severely limit the delivery of high bandwidth service by purely wireless means in a high-density environment. As a result, wireless deployments for individual rooms can be material and labor intensive.

For wired technologies, many products are available through IEEE 802.3 standard using a CAT 5 wire, through DSL technology using a CAT 3 wire, or through DOCSIS compliant technology using coaxial cable. The wired technologies generally give reliable and secure communication channels. Many hotels and apartments have the coaxial cable and telephone lines, but may not have CAT 5 wire installed. As a result, these rooms require extensive re-wiring or installation of new CAT 5 wiring to support IEEE 802.3 technology. For DSL and DOCSIS technologies, it may require expensive installation of network products and supporting non standard client interfaces.

Accordingly, a key aspect of the invention is to utilize a hybrid wired/wireless LAN, the wired portion using the existing wiring infrastructure available at the hotspot 20 as has been previously mentioned. Preferably, the CATV wiring, if available, is used. The chief advantage in using a hybrid network is a substantial reduction in signal attenuation as compared to a typical all wireless network. Given a 100 foot propagation scenario, a hybrid network can yield approximately a 10 dB signal strength advantage versus an all wireless network, even accounting for the relatively indirect routing of CATV wiring through a building. An additional advantage obtained through the use of the hybrid network of the invention is improved signal immunity, given that the longer of the propagation paths, the wired or CATV portion of the network, is through shielded coaxial cable giving inherently superior interference immunity. This advantage can of course be improved upon by increasing the relative proportion of wired portion propagation distance to wireless portion propagation distance. Maximum interference immunity is obtained by an all wired network, which is within the purview of the inventive concept. Further interference immunity is obtained by a frequency distribution scheme as will be explained below. It should be noted that in most cases the existing CATV wiring can be used for the majority of the wired portion of the network.

Referring now to FIG. 6, a structure 30 having pre-existing CATV wiring 38 is shown. The CATV wiring 38 may be fed CATV signals received and processed by a dish 40 and associated receiver circuitry. The wiring 38 is routed through the structure 30 so as to be available in every living space or common area 42, 142, 242, etc. It should be noted that a living space 42 may not be a single room but may be a suite with, e.g., 2 bedrooms, a bathroom, and a living room. Such a living space 42 would require at least two CATV receptacles, but only a single transmitting antenna as will be explained in more detail later.

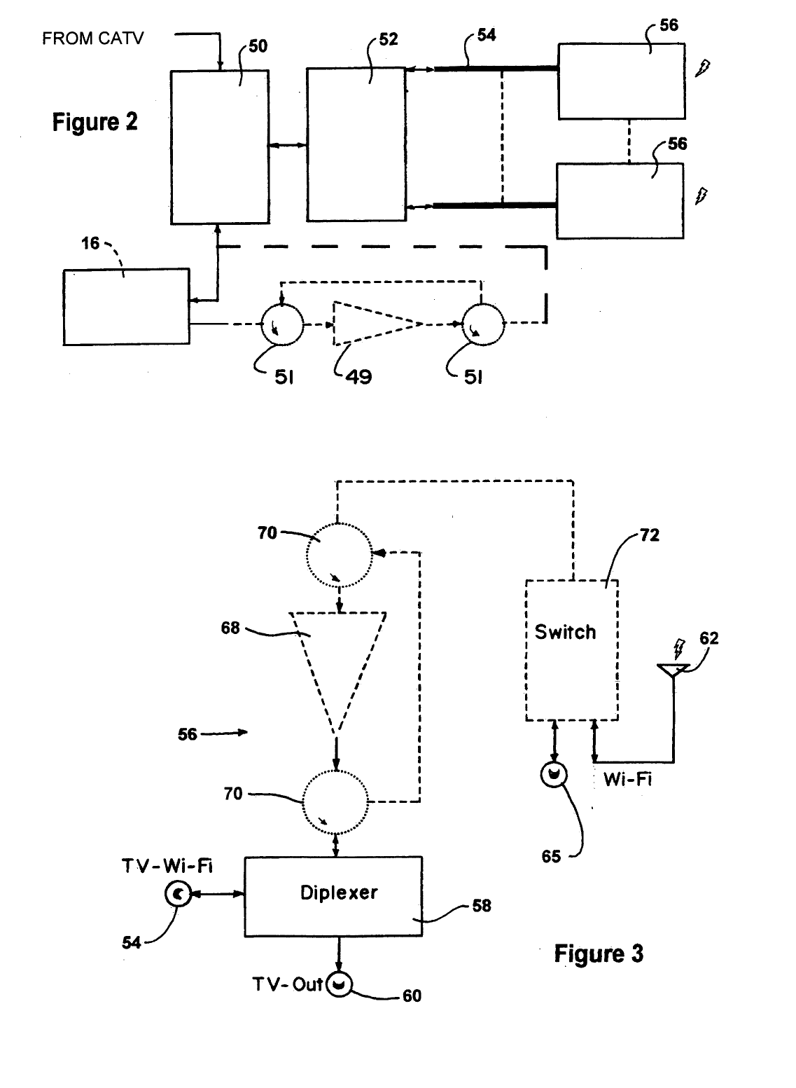

An overall schematic of the hybrid system is shown in FIG. 2. Signals from both the CATV receiver and the access point 16 are applied to a diplexer 50. The access point 16, which is a transceiver built to one of the 802.11 standards, may be one of several commercially available units from such vendors as Orinoco®, Linksys®, or Cisco®. The diplexer 50 combines TV and Wi-Fi signals onto a common port while providing good isolation between the TV and Wi-Fi input ports. The frequency bands of interest afford a wide variety of options for diplexer 50 implementation. In the preferred embodiment, the diplexer 50 utilizes printed circuit elements to implement the desired filtering function. Additional circuit elements shown in dashed lines may be needed where there is increased cable loss between the access point 16 and diplexer 50 as would be the case when there is considerable distance between the access point 16 and diplexer 50. An amplifier 49 and circulators 51 are optionally included to boost signal strength to make up for the increased cable loss. Circulators 51 are employed to preserve bi-directionality of the link.

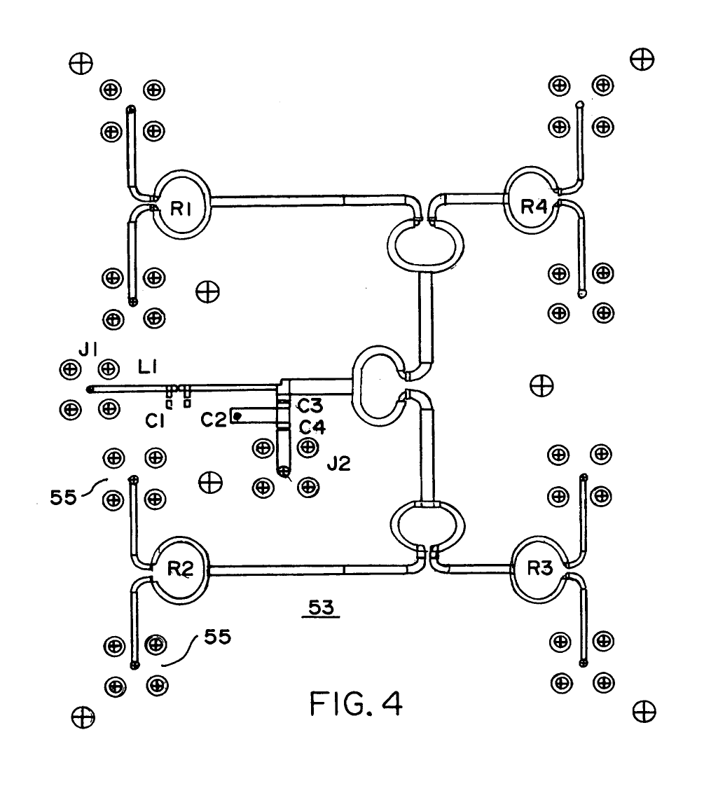

The combined TV and Wi-Fi signals enter a splitter 52 and are divided into several signals of lesser amplitude. The diplexer 50 and splitter 52 may alternatively be combined on to a single printed circuit board as shown in FIG. 4. It can be seen that the PC board 53 shown has input terminals J1 and J2 which serve as inputs for the TV and Wi-Fi signals, with the appropriate DC isolation and filtering circuits comprised of capacitor C1-C4, and indiuctor L1. The card 53 has eight outputs 55, two each connected to resistors R1-R4, and thus functions as an eight way diplexer/splitter.

It should be noted that cable wiring in most buildings is of two types: home run and tapped line. In the home run configuration, cables are run from a central location individually to each room, and all large buildings that have been constructed recently are wired this way. The tapped line configuration is found in older installations where a main line runs down a corridor and is tapped at intervals with splices into individual rooms. The tapped line requires a greater assortment of components to implement and is therefore not the preferred configuration. The more modern home run provides the ideal configuration from the viewpoint of equipment cost, operation, and maintenance. The present invention is readily adapted to both configurations. Accordingly, each splitter output 55 connects to a coaxial cable 54 that runs directly to an individual room or to the main line of a tapped configuration. In the latter case, alternately, the access point 16 may be connected through a diplexer directly into each tapped line, bypassing the main line.

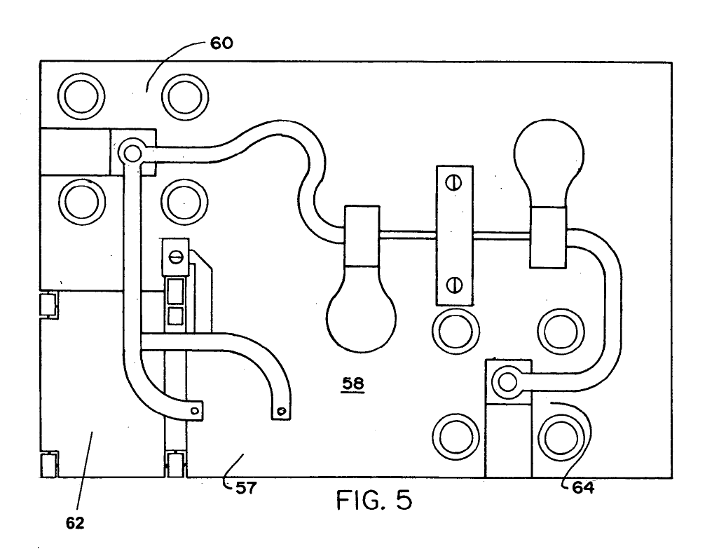

Referring now to FIGS. 3 and 5, each cable 54 terminates in a wall unit 56 that is housed in each room. The wall unit 56, which may also be formed on a single printed circuit board 57 as shown in FIG. 5, consists of a diplexer 58 that separates the TV and Wi-Fi signals along separate paths. The TV signal path terminates in a coaxial connector 60 that passes through a hole centered in an existing plastic wall plate (not shown) and protrudes from the wall plate (not shown) into the living space 42, and to which a TV cable is attached. The Wi-Fi signal path terminates either in a miniature antenna 62 that radiates the energy into the room, or in a coaxial connector 64 that provides a wired connection to the client device 17. Units that have the antenna 62 installed incorporate the wireless segment of the link. A corresponding antenna in the client device 17 receives this signal and channels it to an integral transceiver within the device 17 for further conditioning and processing. Transmitted signals from the client device 17 likewise are received by the antenna 62 in the wall unit 56 and routed through the diplexer 58 and cable 54 back toward the AP 16. In the preferred embodiment, the wall unit's diplexer 58 is implemented with printed circuit board 57 with the antenna 62 and connectors being the only components requiring attachment during assembly of the WLAN. The antenna 62 if present is hidden from view by the wall plate. A modified wall plate is required for cable-only installations, to accommodate the extra terminal 64 needed for the broadband signal.

FIG. 3 includes optional components shown in dashed outline to include cases where longer cable 54 runs may be required than can be supported by only passive components. In such cases, an active amplifier 68 may be included to boost signal strength to make up for the increased cable loss. Circulators 70 are employed to preserve bi-directionality of the link. Clearly, the isolation of these circulators must exceed amplifier 68 gain to ensure stable operation. An RF switch 72 may be included that steers the Wi-Fi signal to the antenna 62 or to the coaxial output 65. While these enhancements increase the cost and complexity of the wall unit 56 because of the increased component count and the need for supplying dc power to the active components, they are unavoidable especially when the network operates in the 2.4 GHz band where cable losses are higher.

In the event that multiple access points 16 are used, each access point 16 may be tuned to a different channel, and broadband signals therefrom may be routed so that adjacent living areas 42 are not on the same channel. Preferably, any two living areas on the same channel are separated by two or more living areas to minimize interference. Referring again to FIG. 6, adjacent rooms 42, 142, 242, and 342 are fed from four different access points (not shown) so that room 42 is on a first channel, 142 is on a second channel, 242, is on a third channel, and 342 is on a cable outlet. Thus, no adjacent rooms are on the same channel to reduce interference. The sequence begins again with room 442 on the first channel, room 542 on the second channel, and so on. Of course, each individual building 30 will have a unique layout, as well as unforeseeable idiosyncrasies, so that the channel assignments should be varied on a case by case basis to maximize the interference reduction obtained by the channel distribution arrangement discussed above. While in the example given a four channel scenario is demostrated, there may be more or fewer channels depending upon the layout of the hotspot 20.

In operation, broadband signals are transmitted between the client device 17 and the local cache gateway 14 along the WLAN 19 at a relatively high speed, the broadband signals containing data and control signals as described above. Accordingly, users of client devices 17 have faster access to their applications because those applications reside at the local gateway 14 and can therefore be downloaded to client devices 17 via the local higher bandwidth link. Furthermore, this benefit is transparent to the particular application; video games, movies, training materials, music, and images can all can be downloaded to client devices via the local high-bandwidth link. A user wishing, for example, to download a software product which has been previously stored on the local cache gateway 14 sends the request via the client device 17 to the central computer 12, which after handling all accounting and other ancillary matters, authorizes the download. Data transmission between the internet 18 and the client device 17 occuring outside of the WLAN 19 is also under control of the central computer 12, albeit at the relatively slow speeds as discussed above.

As has been previously mentioned, the system 10 may be adapted to control and distribute any broadband signal. Thus, for example, the system 10 may be employed to control and distribute cell phone signals in the relevant frequency bands, around 900 Mhz, and 1.9 to 2.1 Ghz.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

1. A digital network for bi-directional communication of digital data between a plurality of closely spaced personal computers located within a predetermined area and a central computer comprising:
a plurality of local cache gateways connected to said central computer for bi-directional communication of said digital data via a decentralized public network at a relatively low data rate;
at least one access point connected to said local gateway for bi-directional communication therewith;
a passive network of interconnected cables, said cables having at least one input terminal and a plurality of output terminals;
a corresponding plurality of transceiver units coupled to some of said output terminals;
said access point connected to said at least one input terminal to facilitate bi-directional communication between said local cache gateways and transceiver units;
whereby said transceiver units and said local cache gateways communicate said digital data at a relatively high data rate.

2. The network of claim 1 wherein said passive network of cables are contained within a single structure.

3. The network of claim 2 wherein said structure is partitioned into a plurality of separate living areas, and wherein said transceiver units are positioned to radiate an RF carrier signal that bears said digital data within said living areas.

4. The network of claim 3 wherein said transceiver units are positioned to receive digital RF signals from any of said digital computers located within a corresponding living area.

5. The network of claim 1 wherein said cables are coaxial cables.

6. The network of claim 1 wherein said network of interconnected cables are CATV cables carrying a CATV signal.

7. The network of claim 6 including diplexing means in proximity of said at least one access point for combining said CATV signal and said signal bearing digital data from said access point to produce a combined signal; and,
dividing means for splitting said combined signal for distribution to said personal computers via said cables.

8. The network of claim 6 including dividing means in proximity of said personal computers for separating said CATV signal from said signal bearing the digital data at locations of said personal computers, said dividing means also providing means for receiving outbound data signals from said personal computers for onward transmission via said cables back to said access point.

9. The network of claim 8 wherein said digital data includes inbound data from said central computer and said outbound data signals from said personal computers, and wherein said dividing means includes means for combining the outbound data signals received from said personal computers for output to said central computer via said access point.

10. The network of claim 6 wherein said diplexing means includes isolation means for isolating said CATV signal from said RF carrier signal.

11. The network of claim 6 wherein said diplexing means includes means for unidirectional amplification of said RF carrier signal.

12. The network of claim 6 wherein said diplexing means includes means to steer said RF carrier signal to an antenna or a connector.

13. A digital network for bi-directional communication of digital data between a plurality of closely spaced client devices located within a predetermined area and a central computer comprising:
at least one gateway device connected to said central computer for bi-directional communication therewith via a relatively low bandwidth backhaul link;
a network of interconnected cables contained within a predetermined area, structure, or group of structures, each of said cables having at least one input terminal and a plurality of output terminals, said at least one input terminal connected to said at least one gateway device;
means for coupling said client devices to said at least one gateway device via said network of interconnected cables to allow for relatively high speed bi-directional communication of said digital data between said client devices and said at least one gateway device.

14. The network of claim 13 wherein said means for coupling said client device to said at least one gateway includes at least one access point connected between said network of interconnected cables and said client devices.

15. The network of claim 13 wherein said predetermined area, structure, or group of structures is partitioned into a plurality of living areas, each of said living areas including a transceiver connected to said access points for bi-directional communication of said digital data therebetween.

16. The network of claim 15 wherein said digital data is transmitted between said access points and said client devices by an RF carrier signal.

17. The network of claim 15 wherein said digital data is transmitted between said access points and said client devices by at least two RF carrier signals of different frequencies, said carrier signals distributed throughout said predetermined area, structure, or group of structures in alternating relation among said living areas.

18. The network of claim 13 wherein said passive network of cables are contained within a single structure.

19. The network of claim 18 wherein said structure is partitioned into a plurality of separate living areas, and wherein said transceiver units are positioned to radiate an RF carrier signal that bears digital data within said living areas.

20. The network of claim 13 wherein said client devices are cell phones and said digital data is voice data.
